(19) United States
(12) Patent Application Publication
(10) Pub. No.: US 2006/0155546 A1
(43) Pub. Date: Jul. 13, 2006

(54) Method and system for controlling input modalities in a multimodal dialog system

(76) Inventors: Anurag K. Gupta, Palatine, IL (US); Hang S. Lee, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/033,066

(22) Filed: Jan. 11, 2005

(51) Int. Cl. G10L 11/00

(52) U.S. Cl. 704/275

(57) ABSTRACT

A method and a system for controlling a set of input modalities in a multimodal dialog system are provided. The method includes selecting (302) a sub-set of input modalities that a user can use to provide user inputs during a user turn. The method further includes dynamically activating (304) the input modalities that are included in the sub-set of input modalities. Further, the method includes dynamically deactivating (306) the input modalities that are not included in the sub-set of input modalities.

### FIELD OF THE INVENTION

The present invention relates to the field of software, and more specifically, it relates to input modalities in a multimodal dialog system.

### BACKGROUND

Dialog systems are systems that allow a user to interact with a system to perform tasks such as retrieving information, conducting transactions, planning, and other such problem solving tasks. A dialog system can use several input modalities for interaction with a user. Examples of input modalities include keyboard, touch screen, microphone, gaze, video camera, etc. User-system interactions in dialog systems are enhanced by employing multiple modalities. The dialog systems using multiple modalities for user-system interaction are referred to as multimodal dialog systems. The user interacts with a multimodal system using a dialog based user interface. A set of interactions of the user and the multimodal dialog system is referred to as a dialog. Each interaction is referred to as a user turn. The information provided by either the user or the multimodal system, in such multimodal dialog systems, is referred to as a dialog context.

Each input modality available within a multimodal dialog system utilizes computational resources for capturing, recognizing, and interpreting user inputs provided in a medium used by the input modality. Typical mediums used by the input modalities include speech, gesture, touch, and handwriting. As an example, a speech input modality connected to a multimodal dialog system uses computational resources that include memory and CPU cycles. The computational resources are used to capture and store user's spoken input, converting raw data into a text-based transcription, and then converting the text-based transcription into a semantic representation that identifies its meaning.

In some conventional dialog systems, the input modalities are always running during the course of a dialog. However, a user may be restricted to use a particular sub-set of input modalities available within the multimodal dialog system based on a task, which the user is trying to complete. Each task has different input requirements that are satisfied by a subset of the available input modalities within a multimodal dialog system. Even when an input modality in a multimodal dialog system is not used by a user, it uses computational resources to detect if the user is providing inputs in a medium used by the input modality. The use of computational resources should be limited on devices with limited computational resources, such as, handheld devices and mobile phones. Thus, the input modalities should be controlled so as to limit the use of computational resources by the input modalities that are not required for providing user inputs for a particular task. Further, there should be a provision for the input modalities to connect to the multimodal dialog system dynamically, i.e., at runtime.

A known method for choosing combinations of input and output modalities describes a ‘media allocator’ for deciding an input-output modality pair. The method defines a set of rules to map a current media allocation to the next media allocation. However, since the set of rules are predefined at the time of compiling of a multimodal dialog, they do not take into account the context of the user and the multimodal dialog system. Further, the set of rules do not take into account the dynamic availability of input modalities. Further, the method does not provide any mechanism for choosing the optimal combinations of input modalities.

Another known method for dynamic control of resource usage in a multimodal system dynamically adjusts resource usage of different modalities based on confidence in results of processing and pragmatic information on mode usage. However, the method assumes that input modalities are always on. Further, each input modality is assumed to occupy a separate share of computational resources in the multimodal system.

Yet another known method describes a multimodal profile for storing user preferences on input and output modalities. The method uses multiple profiles for different situations, for example, meetings, and vehicles. However, the method does not address the issue of dynamic input modality availability. Further, the method does not address the change in input requirements during a user turn.

### BRIEF DESCRIPTION OF THE DRAWINGS

Various embodiments of the invention will hereinafter be described in conjunction with the appended drawings provided to illustrate and not to limit the invention, wherein like designations denote like elements, and in which:

FIG. 1 is a representative environment of a multi-modal dialog system, in accordance with some embodiments of the present invention.

FIG. 2 is a block diagram of a multimodal dialog system for controlling a set of input modalities, in accordance with some embodiments of the present invention.

FIG. 3 is a flowchart illustrating a method for controlling a set of input modalities in a multimodal dialog system, in accordance with some embodiments of the present invention.

FIG. 4 illustrates an electronic device for controlling a set of input modalities, in accordance with some embodiments of the present invention.

### DETAILED DESCRIPTION OF THE INVENTION

Before describing in detail a method and system for controlling input modalities in accordance with the present invention, it should be observed that the present invention resides primarily in combinations of method steps and system components related to controlling of input modalities technique. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

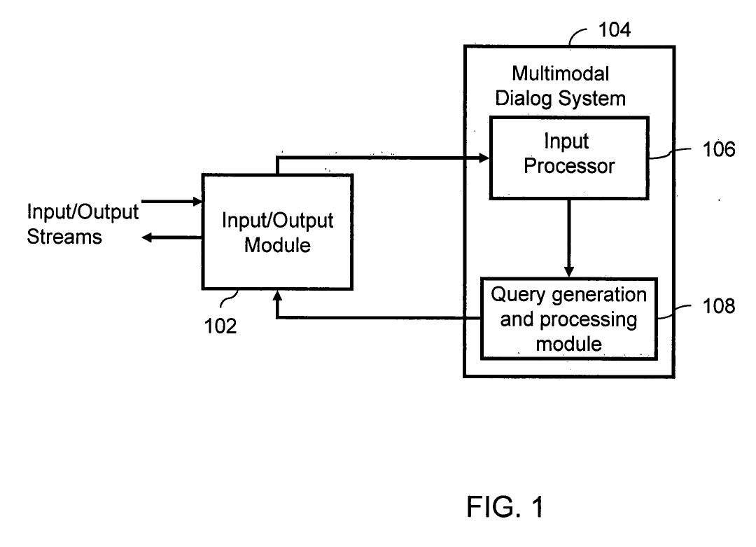

Referring to FIG. 1, a block diagram shows a representative environment in which the present invention may be practiced, in accordance with some embodiments of the present invention. The representative environment consists of an input-output module 102 and a multi-modal dialog system 104. The input-output module 102 is responsible for receiving user inputs and communicating system outputs. The input-output module 102 can be a user interface, such as a computer monitor, a touch screen, a keyboard, or a combination of these. A user interacts with the multimodal dialog system 104 via the input-output module 102. The interaction of the user with the multimodal dialog system 104 is referred to as a dialog. Each dialog may comprise a number of interactions between the user and the multimodal dialog system 104. Each interaction is referred to as a user turn of the dialog. The information provided by the user at each user turn of the dialog is referred to as a context of the dialog.

The multimodal dialog system 104 comprises an input processor 106 and a query generation and processing module 108. The input processor 106 interprets and processes the input from a user and provides the interpretation to the query generation and processing module 108. The query generation and processing module 108 further processes the interpretation and performs tasks such as retrieving information, conducting transactions, and other such problem solving tasks. The results of the tasks are returned to the input-output module 102, which communicates the results to the user using the available output modalities.

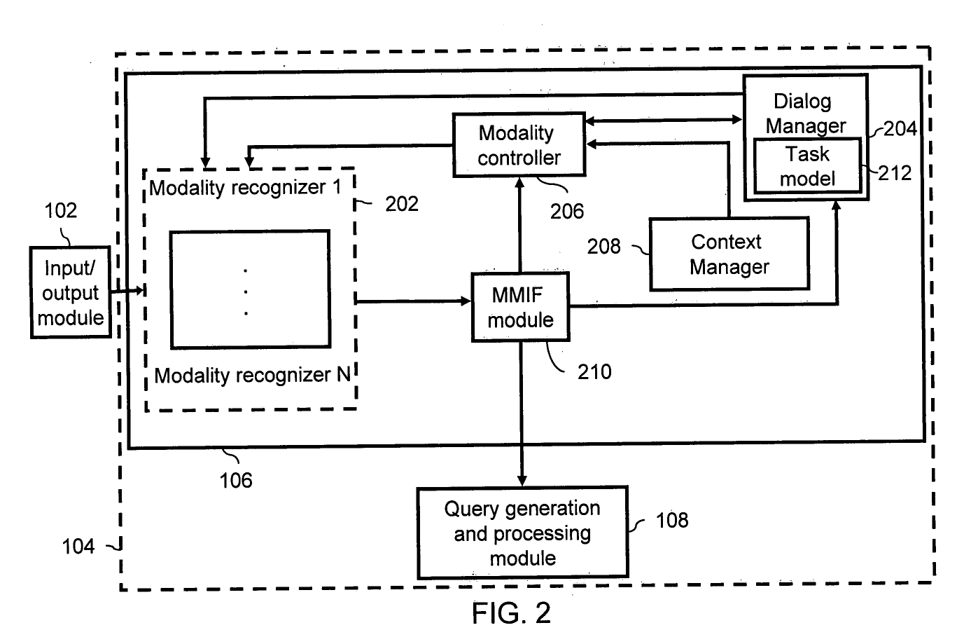

Referring to FIG. 2, a block diagram shows the multimodal dialog system 104 for controlling a set of input modalities, in accordance with some embodiments of the present invention. The input processor 106 comprises a plurality of modality recognizers 202, a dialog manager 204, a modality controller 206, a context manager 208, and a multimodal input fusion (MMIF) module 210. Further, the dialog manager 204 comprises a task model 212. The task model 212 is a data structure used to model a task.

The modality recognizers 202 accept and interpret user inputs from the input-output module 102. Examples of the modality recognizers 202 include speech recognizers and handwriting recognizers. Each of the modality recognizers 202 includes a set of grammars for interpreting the user inputs. A multimodal interpretation (MMI) is generated for each user input. The MMIs are sent by the modality recognizers 202 to the MMIF module 210. The MMIF module 210 may modify MMI's by combining some of them and further sends the MMIs to the dialog manager 204.

The dialog manager 204 generates a set of templates for the expected user input in the next turn of a dialog, based on current dialog context and the current task model 212. In an embodiment of the invention, the current dialog context comprises information provided by the user during previous user turns. In another embodiment of the invention, the current dialog context comprises information provided by the multimodal dialog system 104 and the user during previous user turns, including previous turns during the current dialog while using the current task model. A template specifies information that is to be received from a user, and the form in which the user may provide the information. The form of the template refers to the user intention in providing the information in the input, e.g. request, inform, and wh-question. For example, if the form of a template is a request, it means that the user is expected to make a request for the performance of a task, such as, information on a route between two places. If the form of a template is inform, it means that the user is expected to provide information to the multimodal dialog system 104, such as, providing names of cities. Further, if the form of a template is a wh-question, it means that the user is expected to ask a ‘what’, ‘where’ or ‘when’ type of question at the next turn of the dialog. The set of templates is generated by the dialog manager 204 so that all the possible expected user inputs are included. For this, one or more of the following group of dialog concepts are used: discourse expectation, task elaboration, task repair, look-ahead and global dialog control.

In discourse expectation, the task model 212 and the current dialog context helps in understanding and anticipating the next user input. In particular, they provide information on the discourse obligations imposed on the user at a turn of the dialog. For example, a system question, such as “Where do you want to go?” should result in the user responding with the name of a location.

In some cases, a user may augment the input with further information not required by a dialog, but necessary for the progress of the task. For this, the concept of task elaboration is used to generate a template, to incorporate any additional information provided by the user. For example, for a system question, such as “Where do you want to go?” the system expects the user to provide a location name, but the user may respond with “Chicago tomorrow”. The template that is generated for interpreting the expected user input is such that the additional information (which is ‘tomorrow’ in this example) can be handled. The template specifies that a user may provide additional information related to the expected input, based on the current dialog context and information from the previous turn of the dialog. In the above example, the template specified that the user may provide a time parameter along with the location name, and as in the previous dialog turn, the system knows that the user is planning a trip, as the template used is ‘GoToPlace’.

The concept of task repair offers an opportunity to correct an error in a dialog turn. For the dialog mentioned in the previous paragraph, the system may interpret the user's response of ‘Chicago’ wrongly as ‘Moscow’. The system, at the next turn of the dialog, asks the user for confirmation of the information provided as, “Do you want to go to Moscow?” The user may respond with, “No, I said Chicago”. Hence, the information at the dialog turn is used for error correction.

The concept of the look-ahead strategy is used when the user performs a sequence of tasks without the intervention of the dialog manager 204 at every single turn. In this case, the current dialog information is not sufficient to generate the necessary template. To account for this, the dialog manager 204 uses the look-ahead strategy to generate the template.

To continue with the dialog mentioned in the previous paragraphs, in response to the system question “Where do you want to go?”, a user may reply with “Chicago tomorrow.”, and then “I want to book a rental car too” without waiting for any system output for the first response. In this case, the user performs two tasks, specifying a place to go to and requesting a rental car, in a single dialog turn. Only the first task is expected from the user, given the current dialog information. Templates are generated based on this expectation and the task model 212, which specifies additional tasks that are likely to follow the first task. That is, the system “looks ahead” to anticipate what a user would do next after the expected task.

The user may provide an input to the system that is not directly related to a task, but is required to maintain or repair the consistency or logic of an interaction. Example inputs include a request for help, confirmation, time, contact management, etc. This concept is called global dialog control. For example, at any point in the dialog, a user may ask for help with “Help me out”. In response, the multimodal dialog system 104 obtains instructions dependent on the dialog context. Another example can be a user requesting the cancellation of the previous dialog with “Cancel”. In response, the multimodal dialog system 104 undoes the previous request.

An exemplary template generated by the dialog manager 204 is shown in Table 1. The template for a task ‘GoToPlace’ is used to collect information for going from one place to another. The template specifies that a user is expected to provide information for the task ‘GoToPlace’ with the task parameter ‘Place’. The ‘Place’ parameter in turn has two attribute values, ‘Name’, and ‘Suburb’. The ‘form’ of the template is ‘request’, which means that the user's intention is to request the execution of the task. A template is represented using a type feature structure.

TABLE 1

(template
(SOURCE obligation)
(FORM request)
(ACT
(TYPE GoToPlace)
(PARAM
(Place
NAME “”
SUBURB “”

)

)
)

)

Further, the dialog manager 204 provides grammars to the input modalities to modify their grammar recognition capabilities. The grammar recognition capabilities can be modified dynamically so as to match the capabilities required by the set of templates it generates. The dialog manager 204 also provides to the modality controller 206 information about the grammars that are dynamically provided to the input modalities (dynamic grammars). The provision of grammars dynamically by the dialog manager 204 is hereinafter referred to as grammar provision information. Further, the dialog manager 204 maintains and updates the dialog context of the user-multimodal dialog system 104 interaction.

The templates generated by the dialog manager 204 are sent to the modality controller 206. As mentioned above, the modality controller 206 also receives grammar provision information and a description of the current dialog context from the dialog manager 204. Further, the modality controller 206 receives information on the runtime capabilities of modalities from the MMIF module 210. In an embodiment of the invention, the modality capability information within an input modality is updated dynamically. The modality controller 206 contains rules to determine if an input modality is suitable to be used with a given description of interaction context. In an embodiment of the invention, the rules are pre-defined. In another embodiment of the invention, the rules are defined dynamically. The interaction context refers to physical, temporal, social, and environmental contexts. For example, in a physical context, a mobile phone is placed in a holder in a car. In such a situation, a user cannot use a keypad. A temporal context can be at night time when visibility is low. In such a situation, the touch screen can be deactivated. Further, an example of a social context can be a meeting room where a user cannot use voice medium to give input. The context manager 208 interprets physical, temporal and social contexts of the current user of the multimodal system 104, and also the environment in which the system is running. The context manager 208 provides a description of the interaction context to the modality controller 206 and also to the dialog manager 204. Based on the rules and the information received, the modality controller 206 selects a sub-set of the input modalities from the set of input modalities. The modality controller 206 determines a sub-set (set 1) of input modalities that have the capabilities that match the capabilities required by the generated templates. The modality controller 206 then determines a sub-set (set 2) of input modalities that support dynamic grammars, and that are not in set 1. Thereafter, the modality controller 206 determines a sub-set (set 3) of input modalities from set 2 that can be provided with appropriate grammars by the grammar provision information in the dialog manager 204. The input modalities that are present in set 3 are then added to set 1 to generate a new set (set 4). Input modalities from set 4 that are not suitable to be used with an interaction context are then removed to generate the selected sub-set of input modalities.

The selected sub-set of input modalities is then activated to accept the user inputs provided in that user turn. Thus, the activated input modalities' capabilities match the capabilities required by the set of templates generated, the grammar provision information, and the current interaction context. As an example, if a user is expected to click on a screen to provide a user input, the speech modality can be deactivated. The capabilities of each input modality are maintained and updated dynamically by the NMIF module 210. The MMIF module 210 also registers an input modality with itself when the input modality connects to the multimodal dialog system 104 dynamically. In an embodiment of the invention, the registration process is implemented using a client/server model. During registration, the input modality provides a description of its grammar recognition/interpretation capabilities to the MMIF module 210. In an embodiment of the invention, the MMIF module 210 dynamically may change the grammar recognition and interpretation capabilities of the input modalities that are registered. An exemplary format for describing grammar recognition and interpretation capabilities is shown in Table 2. Consider, for example, a speech input modality that provides grammar recognition capabilities for a navigation domain. Within the navigation domain, capabilities to go to a place (GoToPlace), and find places of interest (FindPOI) are provided. These capabilities match the template description provided by the dialog manager 204.

TABLE 2

1) Name - Speech
2) Output Mode - interpreted
3) Recognition - Grammar based
4) On the fly grammar support - Yes
5) Recognition domain - Navigation
6) Recognition capabilities - GoToPlace, FindPOI, . . .

Further, the MMIF module 210 may combine multiple user inputs provided in different modalities within the same user turn. An MMI is generated for each user input by the corresponding input modality. The MMIF module 210 may generate a joint MMI for the MMIs of the user inputs for that user turn.

The input modalities may also be activated and de-activated based on interaction context received from the context manager 208. As an example, assume that the user is located on a busy street interacting with a multimodal dialog system having speech, gesture, and handwriting as the available input modalities. In this case, the context manager 208 updates the modality controller 206 with the environmental context. The environmental context includes information that the user's environment is very noisy. The modality controller 206 has a rule that specifies not to allow the use of speech if the noise level is above a certain threshold. The threshold value is provided by the context manager 208. In this scenario, the modality controller 206 activates handwriting and gesture, and deactivates both speech and gaze modalities.

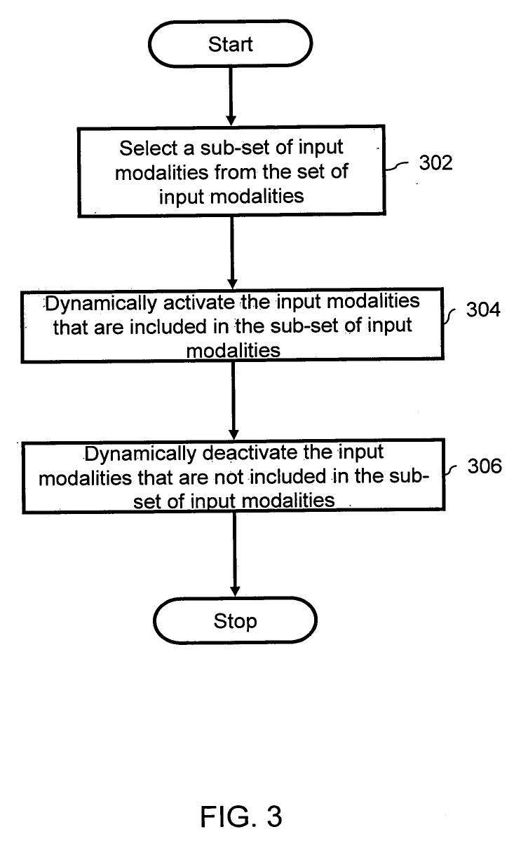

Referring to FIG. 3, a flowchart illustrates a method for controlling a set of input modalities in a multimodal dialog system, in accordance with some embodiments of the present invention. The multimodal dialog system 104 receives user inputs from a user. The user inputs are entered through at least one input modality from the set of input modalities in the multimodal dialog system 104. Based on the task model 212 and the current dialog context, the dialog manager 204 generates a set of templates for expected user inputs. In an embodiment of the invention, the current dialog context comprises information provided by either the user or the multimodal dialog system 104 during previous user turns. The task model 212 includes the knowledge necessary for completing a task. The knowledge required for the task includes the task parameters, their relationships, and the respective attributes required to complete the task. This knowledge of the task is organized in the task model 212. The generated set of templates is sent to the modality controller 206. At the same time, the modality controller 206 receives information pertaining to the set of input modalities from the MMIF module 210. In an embodiment of the invention, the information pertaining to the set of input modalities comprises the capabilities of the input modalities. The modality controller 206 also receives information pertaining to current dialog contexts from the dialog manager 204. Further, the modality controller 206 receives information pertaining to interaction contexts from the context manager 208.

Based on the generated templates and information received (from the MMIF module 210, the dialog manager 204, and the context manager 208), a sub-set of input modalities is selected at step 302. The sub-set of the input modalities is selected from the set of input modalities within the multimodal dialog system 104. In an embodiment of the invention, the sub-set of input modalities is selected by the modality controller 206. The sub-set of input modalities includes input modalities that the user can use to provide user inputs during a current user turn. The modality controller 206 then sends instructions to the dialog manager 204 to provide the input modalities in the selected sub-set of input modalities with appropriate grammars to modify their grammar recognition capabilities. The modality controller 206 then activates the input modalities in the selected sub-set of input modalities, at step 304. The modality controller 206 also deactivates the input modalities that are not in the selected sub-set of input modalities, at step 306. The dialog manager 204 then provides appropriate grammars to the input modalities in the selected sub-set of input modalities.

The modality recognizers 202 in the input modalities use the grammars to generate one or more MMIs corresponding to each user input. The MMIs are then sent to the MMIF module 210. The MMIF module 210 in turn generates one or more joint MMIs from the received MMIs. The joint MMIs are generated by integrating the individual MMIs. The joint MMIs are then sent to the dialog manager 204 and the query generation and processing module 108. The dialog manager 204 uses the joint MMIs to update the dialog context. Further, the dialog manager 204 uses the joint MMIs to generate a new set of templates for the next dialog turn and sends the set of templates to the modality controller 206. The query generation and processing module 108 processes the joint MMIs and performs tasks such as retrieving information, conducting transactions, and other such problem solving tasks. The results of the tasks are returned to the input-output module 102, which communicates the results to the user. The above steps are repeated until the dialog completes. Thus, the method reduces the number of input modalities that are utilizing the system resources at a given time.

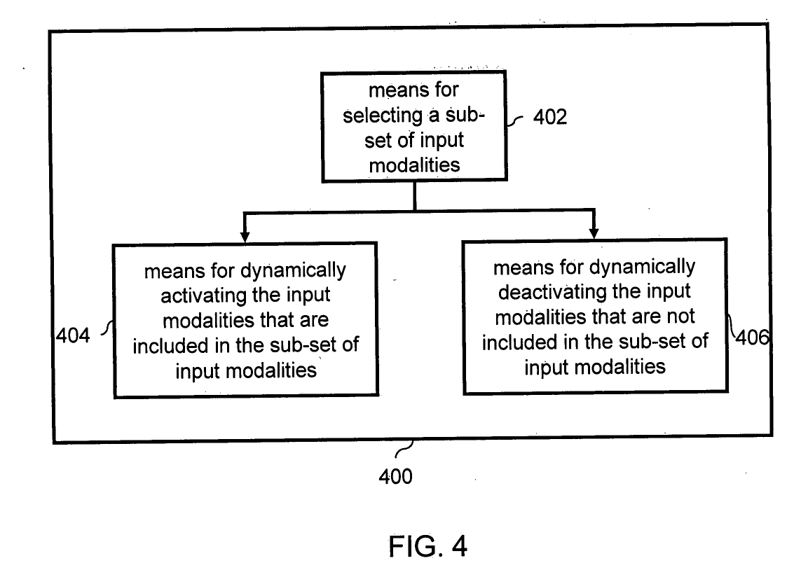

Referring to FIG. 4, an electronic device 400 for controlling a set of input modalities, in accordance with some embodiments of the present invention is shown. The electronic device 400 comprises a means for selecting 402, a means for dynamically activating 404 and a means for dynamically deactivating 406. The means for selecting 402 selects a sub-set of input modalities from the set of input modalities in the multimodal dialog system 104. The means for dynamically activating 404 activates the input modalities in the selected sub-set of input modalities. The dialog manager 204 provides appropriate grammars to the input modalities in the selected sub-set of input modalities to modify their grammar recognition capabilities. The means for dynamically deactivating 406 deactivates the input modalities that are not in the selected sub-set of input modalities.

The technique of controlling a set of input modalities in a multimodal dialog system as described herein can be included in complicated systems, for example a vehicular driver advocacy system, or such seemingly simpler consumer products ranging from portable music players to automobiles; or military products such as command stations and communication control systems; and commercial equipment ranging from extremely complicated computers to robots to simple pieces of test equipment, just to name some types and classes of electronic equipment.

It will be appreciated that the controlling of a set of modalities described herein may be comprised of one or more conventional processors and unique stored program instructions that control the one or more processors to implement some, most, or all of the functions described herein; as such, the functions of selecting a sub-set of input modalities, and activating and deactivating of input modalities may be interpreted as being steps of a method. Alternatively, the same functions could be implemented by a state machine that has no stored program instructions, in which each function or some combinations of certain portions of the functions are implemented as custom logic. A combination of the two approaches could be used. Thus, methods and means for performing these functions have been described herein.

In the foregoing specification, the present invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

A “set” as used herein, means an empty or non-empty set. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “another”, as used herein, is defined as at least a second or more. The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for controlling a set of input modalities in a multimodal dialog system, the multimodal dialog system receiving user inputs from a user, the user inputs being entered through at least one input modality from the set of input modalities in the multimodal dialog system, the method comprising:
dynamically selecting a sub-set of input modalities that the user can use to provide user inputs during a current user turn, the sub-set of input modalities being dynamically selected from the set of input modalities in the multimodal dialog system;
dynamically activating the input modalities that are included in the sub-set of input modalities; and
dynamically deactivating the input modalities that are not included in the sub-set of input modalities.

2. The method in accordance with claim 1 further comprising generating a set of templates for expected user inputs that is used for the dynamic selecting of the sub-set of input modalities, wherein the set of templates being based on a current dialog context, the current dialog context comprising information provided by at least one of the user and the multimodal dialog system during previous user turns.

3. The method in accordance with claim 2 wherein each template in the set of templates is represented as a typed feature structure.

4. The method in accordance with claim 1 wherein the dynamic selecting of the sub-set of input modalities comprises:
receiving information pertaining to the set of input modalities in the multimodal dialog system;
receiving information pertaining to current dialog contexts, the current dialog contexts comprising information provided by at least one of the user and the multimodal dialog system during previous user turns; and
receiving information pertaining to interaction contexts.

5. The method in accordance with claim 4 wherein the information pertaining to the set of input modalities in the multimodal dialog system comprises capabilities of the set of input modalities in the multimodal dialog system, the capabilities being types of user inputs which the input modalities in the set of input modalities can recognize and interpret.

6. The method in accordance with claim 4 wherein the information pertaining to the set of input modalities in the multimodal dialog system is updated dynamically.

7. The method in accordance with claim 4 wherein the interaction contexts are selected from a group of contexts consisting of physical, temporal, social and environmental contexts.

8. The method in accordance with claim 1 further comprising:
sending a grammar to the input modalities that are activated, wherein the grammar is a set of probable sequences for the user inputs;
generating multimodal interpretations (MMIs) based on the user inputs;
integrating the MMIs to generate one or more joint multimodal interpretations (MMIs); and
updating a dialog context with information present in the joint MMIs.

9. A multimodal dialog system comprising:
a plurality of modality recognizers, the modality recognizers interpreting user inputs obtained during user turns of a dialog, the user inputs being obtained through at least one input modality from a set of input modalities in the multimodal dialog system;
a modality controller, the modality controller dynamically controlling the at least one input modality based on user inputs made before, during, or before and during a current dialog

10. The multimodal dialog system in claim 9, wherein the modality controller dynamically controls the at least one input modality further based on an interaction context.

11. The multimodal dialog system in claim 9, wherein the modality controller dynamically selects a sub-set of input modalities that the user can use to provide user inputs during a current user turn, the sub-set of input modalities being selected from the set of input modalities in the multimodal dialog system.

12. The multimodal dialog system in claim 11, wherein the modality controller activates the input modalities that are included in the sub-set of input modalities.

13. The multimodal dialog system in claim 11, wherein the modality controller deactivates the input modalities that are not included in the sub-set of input modalities.

14. The multimodal dialog system in claim 10 further comprising:
a dialog manager, the dialog manager generating a set of templates for expected user inputs that is used by the modality controller, the set of templates being based on a current dialog context, the current dialog context comprising information provided by at least one of the user and the multimodal dialog system during the previous user turns;
a context manager, the context manager providing a description of interaction contexts to the modality controller, the interaction contexts being selected from a group consisting of physical, temporal, social and environmental contexts; and
a multimodal input fusion (MMIF) module, the MMIF module dynamically maintaining and updating capabilities of each input modality, and combining a plurality of multimodal interpretations (MMIS) generated from the user inputs, into joint multimodal interpretations (MMIs) that are provided to the dialog manager.

15. The multimodal dialog system in claim 14, wherein the dialog manager provides information about the grammars that are dynamically provided to the input modalities.

16. The multimodal dialog system in claim 15, wherein the modality controller dynamically controlling the at least one input modality based on the information about the grammars that are dynamically provided to the input modalities by the dialog manager.

17. An electronic equipment for controlling a set of input modalities in a multimodal dialog system, the multimodal dialog system receiving user inputs from a user, the user inputs being entered through at least one input modality from the set of input modalities in the multimodal dialog system, the electronic equipment comprising:
means for dynamically selecting a sub-set of input modalities that the user can use to provide user inputs during a current user turn, the sub-set of input modalities being selected from the set of input modalities in the multimodal dialog system;
means for dynamically activating the input modalities that are included in the sub-set of input modalities; and
means for dynamically deactivating the input modalities that are not included in the sub-set of input modalities.
